(19) United States
(12) Patent Application Publication
(10) Pub. No.: US 2004/0095250 A1
(43) Pub. Date: May 20, 2004

(54) Apparatus and method for detecting an object

(76) Inventors: David J. Chapman, Sterling Heights, MI (US); Lloyd W. Rogers, Shelby TWP, MI (US)

Correspondence Address: CHARLES K. VEENSTRA, ESQ., DELPHI TECHNOLOGIES, INC., Mail Code: 480-414-420, P.O. Box 5052, Troy, MI, 48007-5052, US

(21) Appl. No.: 10/294,716

(22) Filed: Nov. 14, 2002

(51) Int. Cl. G08B 21/00

(52) U.S. Cl. 340/686.6; 340/435; 180/271; 318/471

(57) ABSTRACT

A method and apparatus for providing an obstacle detection system for a vehicle having an automated door or moveable panel, the detection system having a sensing system including a plurality of emitters and detectors disposed proximate to the automated moveable panel or door of the vehicle and a detection circuit in communication with the sensing system, the detecting detection circuit generating an output signal when an object is detected by the sensing system, the output signal is received by a motor control unit of the moveable panel or door and movement of the moveable panel or door is prevented when the output signal is received.

### BACKGROUND

The present disclosure relates generally to proximity detecting systems and, more particularly, to a non-contact obstacle detection system (for example, a human obstacle) that may be implemented in conjunction with a motor vehicle power lift-gate.

Various systems have been devised for detecting obstacles (e.g., humans) in the path of a moveable panel such as an automotive power window, power sliding door or power hinged door. When an obstacle is detected, forward movement (e.g., closing) of the panel is interrupted and, optionally, the movement of the panel may be thereafter reversed (e.g., opened). These detection systems may generally be characterized as either “contacting” or “non-contacting”. In a contacting system, an obstacle is detected only after some form of physical contact occurs between the panel and the obstacle, and may include devices such as pneumatic/pressure sensitive strips, or possibly sensors responsive to changes in mechanical or electrical loading in the apparatus that moves the panel.

On the other hand, in a non-contacting system, an obstacle is detected before actual contact occurs. One specific type of non-contacting obstacle detection system employs the use of a capacitive element(s) as a proximity sensor(s). Capacitive proximity sensors may include one or more electrical conductors formed along the leading edge of a moveable panel, as well as a capacitance sensitive circuit (e.g., a bridge circuit or an oscillator) coupled to the conductor(s). An obstacle (e.g., a human hand) in proximity to the conductor(s) changes the capacitance of the sensor, which change is thereafter detected by the capacitive sensitive circuit.

### SUMMARY

A method and apparatus for providing an obstacle detection system for a vehicle having an automated door or moveable panel, the detection system having a sensing system including a plurality of emitters and detectors disposed proximate to the automated moveable panel or door of the vehicle and a detection circuit in communication with the sensing system, the detecting detection circuit generating an output signal when an object is detected by the sensing system, the output signal is received by a motor control unit of the moveable panel or door and movement of the moveable panel or door is prevented when the output signal is received.

In an exemplary embodiment, the system includes a sensing element disposed in proximity to a moveable panel and a proximity detection circuit in communication with the sensing element. The proximity detection circuit generates a differential output signal reflective of whether a foreign object is in proximity to the sensing element. In addition, a central control module is in communication with the sensing element. The central control module determines whether the differential output signal is reflective of a foreign object in proximity to the sensing element. If the central control module determines that the differential output signal is reflective of a foreign object in proximity to the sensing element, and the moveable panel is moving toward a closed position, then the central control module generates a control output signal to stop the moveable panel from moving toward the closed position.

### BRIEF DESCRIPTION OF THE DRAWINGS

FIGS. 1A and 1B are perspective views of a vehicle having non-contact obstacle detection system;

FIGS. 2A and 2B are side elevational views of non-contact obstacle detection systems;

FIG. 3 is a schematic drawing of a control circuit for the non-contact obstacle detection system of the present disclosure;

FIG. 4 is a cross-sectional view of a component of the non-contact obstacle detection system of the present disclosure; and

FIG. 5 is a schematic drawing of a portion of the non-contact obstacle detection system of the present disclosure.

### DETAILED DESCRIPTION

Disclosed herein is a non-contact obstacle detection system that utilizes sensor techniques to control the movement of an electrically powered system such as power lift-gates, power sliding doors, power deck lids, or a moving door of a vehicle.

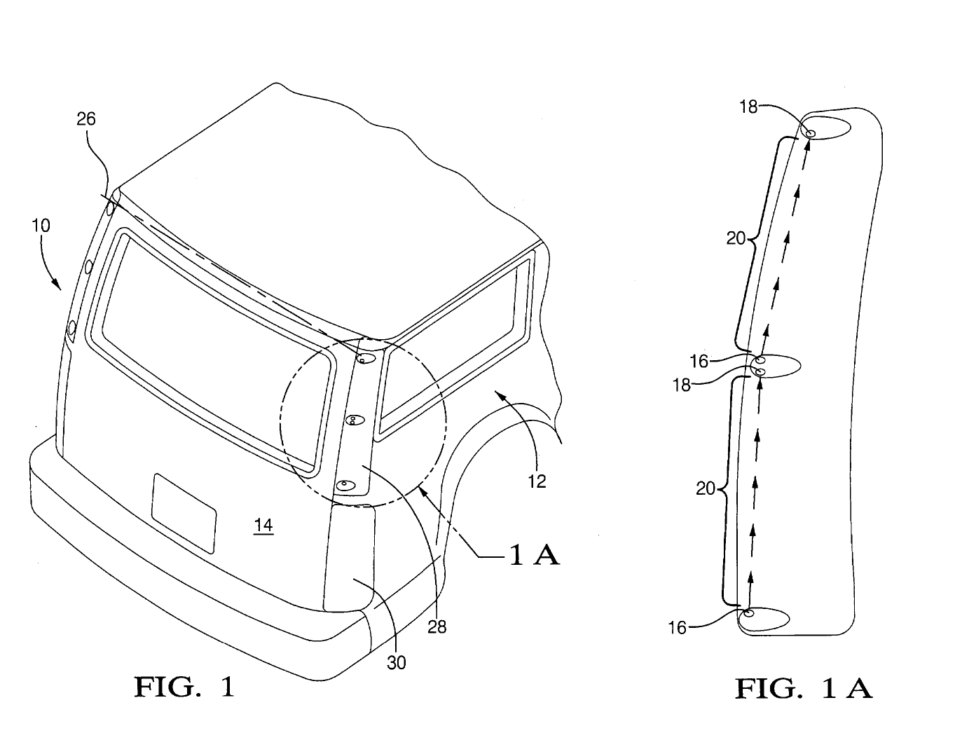

Referring initially to FIGS. 1A and 1B, there is shown a non-contact obstacle detection system 10, in accordance with an embodiment of the present disclosure. Non-contact system 10 is configured to be used on a vehicle 12 having a liftgate or door 14 having an automatic power closure feature. The non-contact obstacle detection system of the present disclosure is contemplated for use on any closing element and is not specifically limited to vehicular applications. The primary goal of the non-contact obstacle detection system is to detect the presence of an obstacle before, during and after a closing or opening sequence has been initiated.

The non-contact obstacle detection system of the present disclosure uses a plurality of infrared light emitting diodes 16(LEDs) and a plurality of photo detectors 18, which are configured to detect the signals emitted by the LEDs 16. Contemplated LEDs 16 and detectors 18 are similar to those used in remote control applications for example, remote controls for televisions, radios, etc. In addition, LEDs 16 and detectors 18 maybe similar to those used in wireless devices used for data transfer in other electronic devices such as computers, personal display assistants (PDAs), and cell phones etc.

The non-contact obstacle detection system of the present disclosure detects the presence of an obstacle when a signal path 20 between an LED and its complementary detector is broken or obstructed. Path 20 is broken when the obstacle enters an area occupied by path 20 and accordingly, the detector is no longer able to detect the infrared light being admitted by its complementary LED 16. When this occurs a control circuit 22 will provide a signal to a motor controller 24 for liftgate 14. The signal will instruct the closing or opening sequence of liftgate 14 to stop. In addition, and as an alternative when motor controller 24 receives such a signal the controller can also be configured to reverse the closing sequence.

In the illustrated embodiment, four pairs of emitters 18 and detectors 18 are used. Of course, the number of detectors and emitters may vary depending on the amount of coverage required and the curvature of the surface on which they are disposed. As illustrated in the Figures the area surrounding liftgate 14 is monitored by disposing detectors and emitter along the sides of the opening for the liftgate. For example, the emitter and detectors are disposed from a hinge line 26 down to an area 28 above a taillight 30 of the vehicle. Thus, the two pairs of emitters and detectors define a path from above the taillight to the height of the hinge line. Of course, it is contemplated that the emitters and detectors are capable of being positioned to define path 20 along other lines and areas of the vehicle.

In the present disclosure a first side of the liftgate is monitored by a first emitter 16 disposed proximate to the hinge line. The first LED emitter provides a beam of infrared light, which is received by a first detector disposed between the hinge line and the taillight, preferably at a point of curvature 32 representing the largest difference (identified as x) between the emitter and detector. A second emitter is also disposed at the point of curvature to provide a beam of infrared light, which is received by a second detector disposed proximate to the taillight. As will be discussed herein the beams of infrared light are modulated to improve detection of the same.

Of course, the positioning, number and angular configuration of the emitters and detectors may vary and the positioning and angular configurations illustrated in the Figures are intended to provide examples, and the present disclosure is not intended to be limited to the same. For example, if the area of the vehicle being monitored is sufficiently flat a single pair of emitters and detectors may suffice.

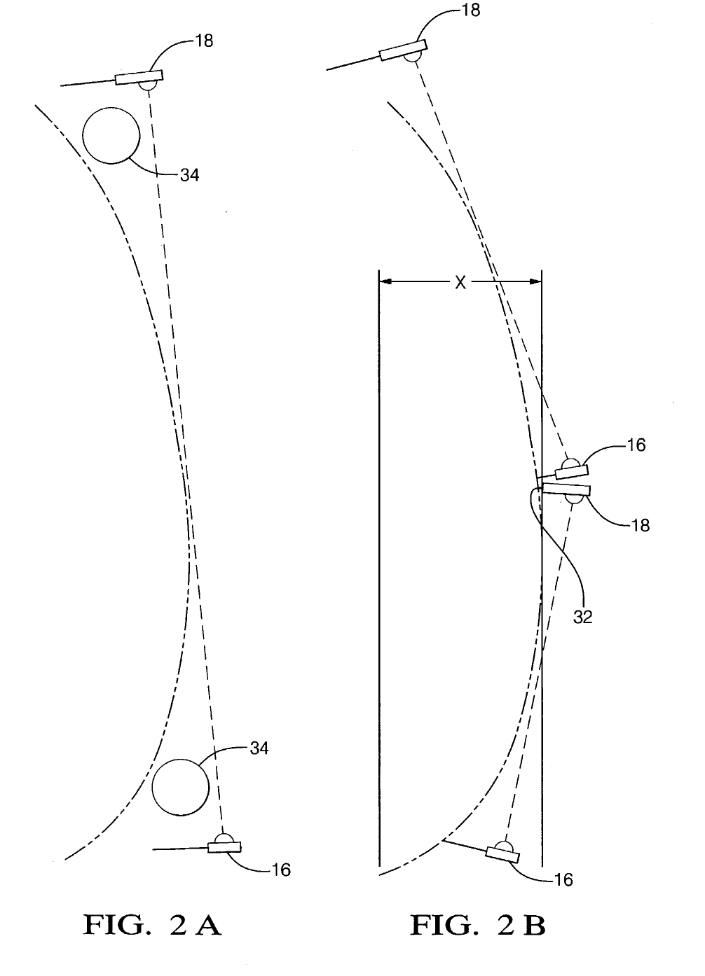

FIG. 2A illustrates the potential for an object 34 of a certain size, which may not be large enough to obstruct the path of light or signal between a single emitter and detector located along an edge of the liftgate opening having angle of curvature illustrated the Figure. Of course, the angle of curvature and size of object 34 may vary, FIG. 2B illustrates that two pairs of emitters and detectors are able to be positioned to locate the path of light or signal closer to the surface of the area being monitored as opposed to a single emitter and detector positioned along an area of a similar curvature. In addition, the pair of emitters and detectors on the same side of the vehicle are sequenced to prevent the system from being tricked into a false reading.

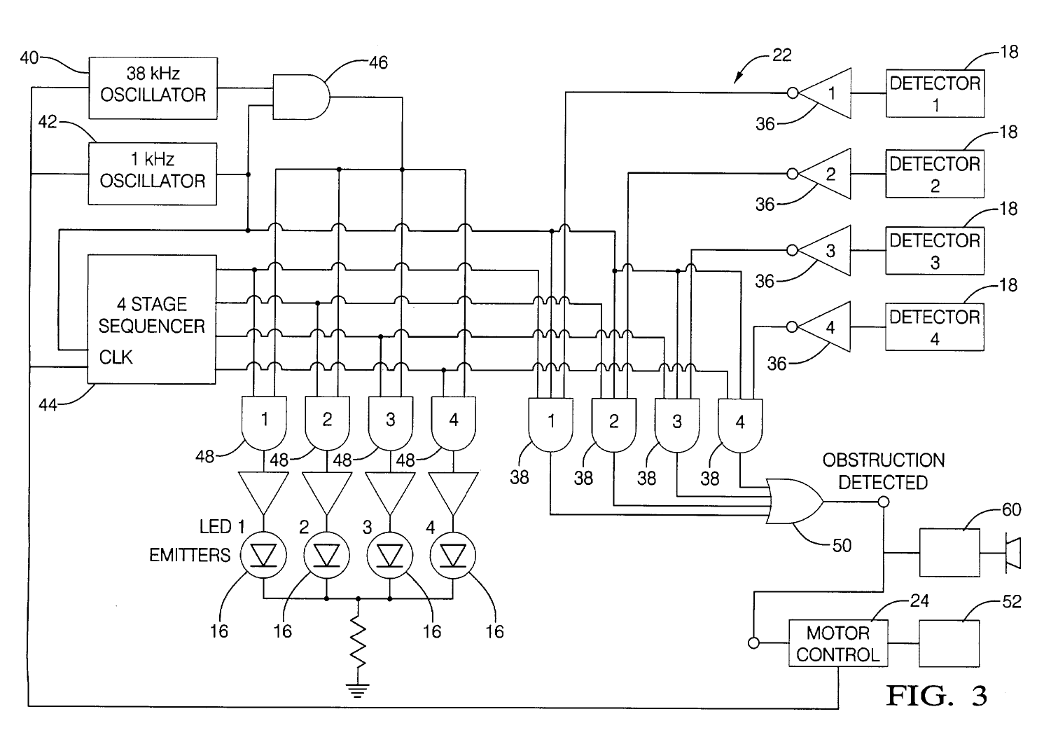

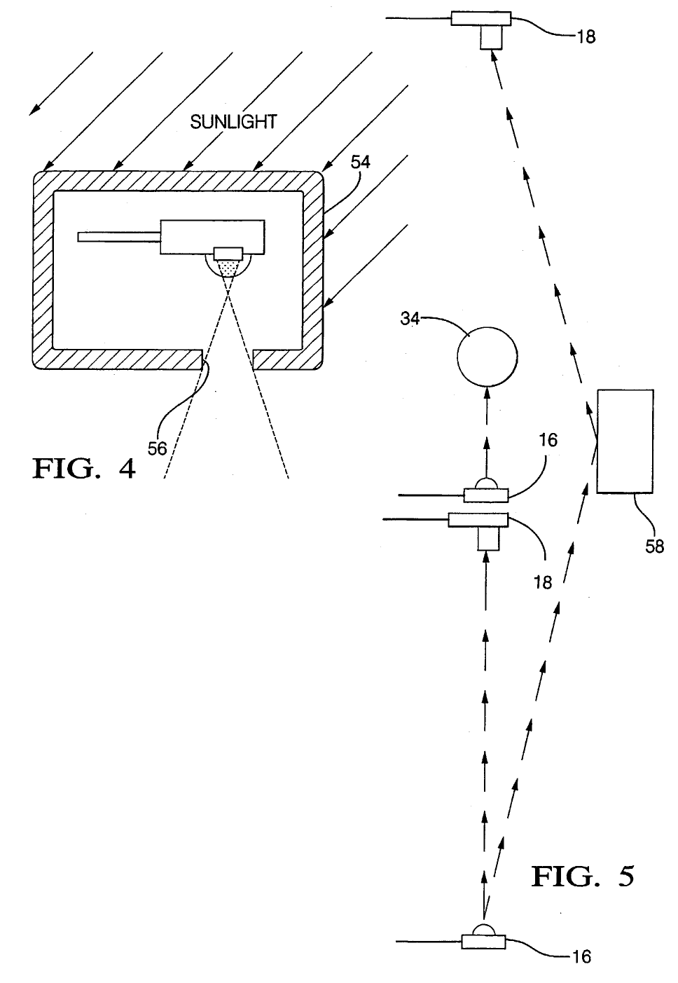

FIG. 3 illustrates an exemplary control circuit 22 for use in the four pair (emitter/detector) arrangement illustrated in FIGS. 1 and 2. Of course, the number of pairs may vary. As illustrated each detector (identified as 1-4, representing four detectors in total) is adapted to provide a signal to an inverter gate or NOT gate 36 (corresponding to each of the detectors), which inverts the signal of the detector. The outputted or inverted signal of the gates 36 is then inputted into a corresponding input of a three input AND gate 38 (corresponding to each of the detectors).

Also shown in FIG. 3 is a first oscillator 40, a second oscillator 42 and a 4 state sequencer or clock 44. In the illustrated embodiment first oscillator 40 is a 38 Kilohertz (KHZ) oscillator and second oscillator 42 is a 1 Kilohertz (KHZ) oscillator. Of course, and as applications may require the values of the oscillators may be greater or less than the aforementioned values.

The 38 Kilohertz frequency of the first oscillator is used to make the emitter and detector of the present disclosure more tolerant to ambient light. Infrared LEDs and infrared photo detectors are used in the present disclosure. In order to improve the detection or make the system more tolerant to ambient light the infrared (IR) signal is modulated and when the signal is detected the system will verify that the detected signal is also modulated. The modulation of the signals and confirmation of receipt of the modulated signal will be conducted in accordance with known technologies. This signal modulation will prevent the detectors from being tricked by detecting ambient light instead of infrared light.

The 1 Kilohertz frequency of the second oscillator is used to drive the clock of the sequencer as well as being inputted to the same gate (46) as the first oscillator. Accordingly, the sequencer will advance every millisecond. The combined input of the first and second oscillators will advance the sequencer and will instruct each of the emitters to sequentially emit a modulated signal.

The outputs of the oscillators 40 and 42 are inputted into a two input AND gate 46, which is configured to provide a corresponding output or signal to an input of each of a plurality of two input AND gates 48 (one of each corresponding to one of the plurality of LEDs 16). In addition, each of the AND gates 48 receives an input from the four state sequencer 44.

In addition, each of the AND gates 38 also receives an input from the four state sequencer 44. AND gates 38 also receive a signal from oscillator 42 as well as the emitters. The four state sequencer 44 is used to drive the circuit through a sampling sequence wherein the emitter 1 is driven and the circuit looks to see if the modulated light of emitter 1 is received by detector 1, then, the circuit drives and checks emitter 2 and detector 2, etc. until it returns back to emitter 1 and detector 1. This circuit will operate continuously. The circuit is also configured to operate in a manner wherein the specific signals of each emitter are looked for receipt by a specific detector. If an obstacle is detected a fault signal is sent to the motor controller of the liftgate. The system can be configured to operate continuously or alternatively be configured to operate only when the motor control system of the motorized liftgate has been activated (e.g., closing or opening).

The sequence of the system is also used to prevent the system from obtaining a false reading through a reflection of the IR signal. Referring now to FIG. 5, if a first emitter 16 emits a modulated signal that is detected by a first photo detector 18, the circuit will determine that the path between the first two devices has not been broken and no obstacle has been detected. The circuit through the operation of the clock sequencer will then determine whether the signal of the second emitter 16 is now being received by the second photo detector 18. As illustrated, in FIG. 5 it may be possible that a reflective object 58 is positioned to receive the signal of first emitter 16 and reflect it towards second detector 18. In addition, an obstruction 34 can also be positioned to block the signal from the second emitter 16. However, since the non-contact obstacle detection system of the present disclosure sequences through each pair of emitters and detectors, the circuit will not be tricked by the reflective object illustrated in FIG. 5, as it will determine that the signal of the second emitter has not been received by the second detector. Accordingly, the sequencing of the system of the present disclosure prevents a detector from receiving a signal from an incorrect emitter.

Referring back now to FIG. 3, the output of the second oscillator is also received by each of the AND gates 38. Accordingly, each of the outputs of AND gates 38 are inputted in an OR gate 50, which will provide a signal or output indicative of whether one of the detectors is not receiving a signal from one of the emitters (e.g., an obstacle has been detected).

The output signal of OR gate 50 is then inputted or received into motor control unit 24, which will provide a signal to a motor 52 instructing the same to stop operating if an obstruction is detected by the system. If a broken light path is detected, a microprocessor within the motor control unit 24, will then send a signal to the power door control module through a data line which will cause the power door control module stop the closing or alternatively opening motion of the door. In an exemplary embodiment the microprocessor of the motor control and door control module are one in the same. Alternatively, the controllers for the power door and motor control are located in two separate microprocessors.

Accordingly, non-contact obstacle detection system 10 includes one or more sensing elements (16, 18), each configured to provide a beam of light, which when broken by an obstacle will produce a signal to prevent actuation of the door when an obstacle is detected. The control circuit 22 of non-contact obstacle detection system 10 is capable of being written into the memory of a microprocessor of the vehicle, preferably the same microprocessor that operates the motorized liftgate.

Also, it is noted that the control circuit is activated upon receipt of signal to the motor control unit to either open or close the motorized door.

In addition, the non-contact obstacle detection system of the present disclosure is contemplated for use with a control scheme configured for detecting the amount of torque or current being applied to motor 52 to open or close the liftgate. For example, motor control unit 24 will include a control system to monitor the amount of current motor 52 is drawing or alternatively how much torque a shaft of the motor is applying in order to open or close the liftgate. If the control system determines that the motor is operating outside of the prescribed range (e.g., normal amount of current or torque required to open or close the liftgate) then the control system will instruct the motor to stop operating, and as an alternative reverse its direction. It being understood to one skilled in the art that the range of operating the motor to open the liftgate will be higher than the range of operation for closing the liftgate. Alternatively, the non-contact obstacle detection system of the present disclosure is also contemplated as a stand alone obstacle system.

Each of the emitters and detectors will be positioned within a nodule or housing 54 disposed on the surface of the vehicle. In one embodiment nodule 54 is secured to a trim portion of the vehicle. Alternatively, the nodule is formed as part of the trim portion. Nodule 54 will have a relatively low profile so as not to excessively protrude from the surface to which it is mounted. In addition, nodule 54 will also have an opening 56 configured to allow either the detector to receive the infrared light or alternatively, the emitter to emit the infrared light. Nodule 54 will provide a housing for the emitter or detector to protect it form debris or impacts, which may damage or adversely affect performance of the device. As yet another alternative nodule or housing 54 may be configured to provide an aesthetically pleasing piece of the trim of the vehicle.

The housing in particular protects the detector from outside light sources such as sunlight. Sunlight has a significant amount of near infrared light. Such large light sources can saturate the infrared detectors. Accordingly, by limiting the field of view of the detectors the present disclosure is able to control this. Therefore, placing the detectors behind a small aperture (opening 56) prevents large amounts of sunlight from saturating the detector.

In the event one of the emitters or detectors becomes blocked by dirt or debris or fails to operate through a mechanical failure, the system is provided with a fail-safe mode of operation. The fail-safe detection of an obstruction is a “failsafe” type of failure because the liftgate will not power close if an obstruction is detected. In order for the operator to distinguish between a situation, which causes the liftgate to not power close, that is caused by a false obstruction detection or which is caused by some other failure of the system, the following operational sequence or system is employed.

When an obstruction is detected while the gate is closing or attempting to close an error signal will be generated. The error signal, which may be an audible tone, will tell the operator that an obstruction was detected. The audible tone will be provided by a noise emitting device and controller 60 that is also configured to receive the output signal of OR gate 50. The operator will then check the area around the liftgate and if no obstruction is found, the sensors may be in need of cleaning as the signal may be blocked. Alternatively, if the liftgate does not close and no audible signal is not present, then it is not the failure of the obstruction sensing system which is causing the liftgate to not power close. In this situation the operator or service mechanic will know that there is some other type of problem associated with the device.

The sensor system is able to detect and signal if it is not functioning properly or fall in a failsafe mode such that it signals an object has been detected (audible tone) if the sensor system has an internal failure. For example, if the 38 kilohertz oscillator stops oscillating (e.g., system fault) none of the detectors would receive a signal and an obstruction would be detected and an audible tone will be heard. Alternatively, and if the one kilohertz oscillator stops oscillating (e.g., system fault), one emitter would be continuously be emitting. The configuration of the system and the detectors require that the emitters are oscillating for a predetermined period for example, 500 microseconds and then off for 500 microseconds. Otherwise, the detectors signal that the beam has been broken (e.g., obstructed) and an object is detected. Thus, the system will provide a signal (audible tone) if it detects an object or the system has an internal failure. In yet another alternative, the audible tone of a detected obstruction can be a single continuous audible noise or tone, while an internal failure of the system can be associated with an intermittent tone or vice versa. It is noted that the predetermined period can be greater or less than 500 microseconds.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An obstacle detection system for a vehicle having an automated door or moveable panel, comprising:
a sensing system comprising a plurality of emitters and detectors disposed proximate to the automated moveable panel or door of the vehicle;
a detection circuit in communication with said sensing system, said detecting detection circuit generating an output signal when an object is detected by said sensing system, said output signal is received by a motor control unit of the moveable panel or door and movement of the moveable panel or door is prevented when said output signal is received.

2. The obstacle detection system as in claim 1, wherein said sensing system comprises:
a first portion, said first portion comprising two pairs of emitters and detectors, said first portion being disposed along a path proximate to an opening of the moveable panel or door; and
a second portion, said second portion comprising two pairs of emitters and detectors, said second portion being disposed along another path proximate to said opening.

3. The obstacle detection system as in claim 2, whereupon receipt of a door closing or opening signal by the motor control unit, said detection circuit begins a sequence comprising:
instructing a first emitter of said first portion to produce a first signal and if said first signal is received by a first detector of said first portion, said detection circuit instructs a second emitter of said first portion to produce a second signal and if said second signal is received by a second detector of said first portion, said detection circuit instructs an emitter of said second portion to produce a third signal and if said third signal is received by a detector of said second portion, said detection circuit instructs another emitter of said second portion to produce a fourth signal and if said fourth signal is received by another detector of said second portion;
wherein said detection circuit repeats said sequence until said door closing or opening signal by the motor control unit is no longer received.

4. The obstacle detection system as in claim 1, wherein said plurality of emitters are infrared light emitting diodes (LEDs) and said detectors are infrared photo detectors.

5. The obstacle detection system as in claim 4, wherein said plurality of detectors are each positioned with a housing having an opening configured to align with a complimentary infrared light emitting diode.

6. The obstacle detection system as in claim 5, whereupon receipt of a door closing or opening signal by the motor control unit, said detection circuit begins a sequence comprising:
instructing a first emitter of said first portion to produce a first signal and if said first signal is received by a first detector of said first portion, said detection circuit instructs a second emitter of said first portion to produce a second signal and if said second signal is received by a second detector of said first portion, said detection circuit instructs an emitter of said second portion to produce a third signal and if said third signal is received by a detector of said second portion, said detection circuit instructs another emitter of said second portion to produce a fourth signal and if said fourth signal is received by another detector of said second portion;
wherein said detection circuit repeats said sequence until said door closing or opening signal by the motor control unit is no longer received.

7. The obstacle detection system as in claim 5, wherein said opening shields said detector from direct sunlight.

8. The obstacle detection system as in claim 4, wherein said plurality of infrared light emitting diodes produce a modulated signal.

9. The obstacle detection system as in claim 8, whereupon receipt of a door closing or opening signal by the motor control unit, said detection circuit begins a sequence comprising:
instructing a first emitter of said first portion to produce a first signal and if said first signal is received by a first detector of said first portion, said detection circuit instructs a second emitter of said first portion to produce a second signal and if said second signal is received by a second detector of said first portion, said detection circuit instructs an emitter of said second portion to produce a third signal and if said third signal is received by a detector of said second portion, said detection circuit instructs another emitter of said second portion to produce a fourth signal and if said fourth signal is received by another detector of said second portion;
wherein said detection circuit repeats said sequence until said door closing or opening signal by the motor control unit is no longer received.

10. The obstacle detection system as in claim 7, wherein said detection circuit comprises a first oscillator for producing said modulated signal.

11. The obstacle detection system as in claim 10, wherein said detection circuit further comprises a clock sequencer for discretely operating each of said plurality of emitters and detectors.

12. The obstacle detection system as in claim 11, whereupon receipt of a door closing or opening signal by the motor control unit, said detection circuit begins a sequence comprising:
instructing a first emitter of said first portion to produce a first signal and if said first signal is received by a first detector of said first portion, said detection circuit instructs a second emitter of said first portion to produce a second signal and if said second signal is received by a second detector of said first portion, said detection circuit instructs an emitter of said second portion to produce a third signal and if said third signal is received by a detector of said second portion, said detection circuit instructs another emitter of said second portion to produce a fourth signal and if said fourth signal is received by another detector of said second portion;
wherein said detection circuit repeats said sequence until said door closing or opening signal by the motor control unit is no longer received.

13. The obstacle detection system as in claim 1, wherein said detection circuit further comprises a clock sequencer for discretely operating each of said plurality of emitters and detectors.

14. A detection system for an opening of a motorized door of a vehicle, comprising:
a first emitter, a second emitter, a third emitter and a fourth emitter;
a first detector, configured and positioned to receive a signal from said first emitter, a second detector, configured and positioned to receive a signal from said second emitter, a third detector, configured and positioned to receive a signal from said third emitter and a fourth detector, configured and positioned to receive a signal from said fourth emitter, each being adapted to communicate a signal to a logic circuit for determining whether an appropriate signal has been received by one of said first detector, said second detector, said third detector or said fourth detector;
a sequencer for sequentially driving said first emitter, said second emitter, said third emitter and said fourth emitter; and
wherein said logic circuit provides an obstruction signal to a motor controller of the motorized door in the event an appropriate signal has not been received by one of said first detector, said second detector, said third detector or said fourth detector, said obstruction signal causes said motor controller to stop operating the motorized door.

15. The detection system as in claim 14, wherein said first emitter, said first detector, said second emitter and said second detector are disposed about a side of the opening.

16. The detection system as in claim 15, wherein said third emitter, said third detector, said fourth emitter and said fourth detector are disposed about another side of the opening.

17. The detection system as in claim 14, wherein first emitter, said first detector, said second emitter and said second detector are disposed about a side of the opening on a portion of the vehicle, said portion being curved and said first detector and said second emitter being positioned on said portion at an area corresponding to the highest point of curvature of said portion to define a line of sight between said first emitter and said first detector and said second emitter and said second detector.

18. The detection system as in claim 17, wherein said third emitter, said third detector, said fourth emitter and said fourth detector are disposed about another side of the opening on another portion of the vehicle, said another portion being curved and said third detector and said fourth emitter being positioned on said another portion at an area corresponding to the highest point of curvature of said another portion to define a line of sight between said third emitter and said third detector and said fourth emitter and said fourth detector.

19. The detection system as in claim 14, wherein said signal from said first, second, third and fourth emitters is an infrared signal and said infrared signal is modulated by a first oscillator.

20. The detection system as in claim 19, wherein said first oscillator is a 38 Kilohertz oscillator.

21. The detection system as in claim 20, further comprising a second oscillator adapted to provide signals to said logic circuit.

22. The detection system as in claim 14, wherein logic circuit also provides an audible to when said logic circuit provides said obstruction signal.

23. A method for determining whether an object is proximate to an opening of an automated door of a vehicle, comprising:
emitting a first signal of infrared light from a first emitter;
determining whether said first signal of infrared light has been received by a first detector configured and positioned to receive said first signal of infrared light traveling along a path disposed proximate to the opening;
emitting a second signal of infrared light from a second emitter only if said first signal of infrared light has been received by said first detector;
determining whether said second signal of infrared light has been received by a second detector configured and positioned to receive said second signal of infrared light traveling along another path disposed proximate to the opening;
wherein an obstacle detected signal is sent to a motor controller of the door if either said first or second signal is not received, said obstacle detected signal will cause said motor controller to stop movement of the door.

24. The method as in claim 23, wherein an audible tone is made if said obstacle is detected and said signal is sent to said motor controller.
